(19) United States
(12) Patent Application Publication
(10) Pub. No.: US 2017/0310602 A1
(43) Pub. Date: Oct. 26, 2017

(54) TRANSMISSION DEVICE AND TRAFFIC CONTROL METHOD

(71) Applicant: FUJITSU LIMITED, Kawasaki-shi (JP)

(72) Inventors: Yukiko Tsubono, Kyoto (JP); Masao Nakano, Takarazuka (JP)

(73) Assignee: FUJITSU LIMITED, Kawasaki-shi (JP)

(21) Appl. No.: 15/445,135

(22) Filed: Feb. 28, 2017

(30) Foreign Application Priority Data
Apr. 20, 2016 (JP) 2016-084765

(51) Int. Cl. H04L 12/823; H04L 12/26; H04L 12/721

(52) U.S. Cl. CPC H04L 47/32; H04L 45/66; H04L 43/0894; H04L 43/16

(57) ABSTRACT

A transmission device includes a plurality of devices through which a plurality of paths in the transmission device passes; and a processor included in a device among the plurality of devices, the processor configured to receive a first packet, measure a first transmission rate of the received first packet, generate a second packet such that a total of the first transmission rate of the first packet and a second transmission rate of the second packet becomes a predetermined value, and output the generated second packet to a path through which the received first packet has been transmitted, from among the plurality of paths.

### CROSS-REFERENCE TO RELATED APPLICATION

This application is based upon and claims the benefit of priority of the prior Japanese Patent Application 2016-084765, filed on Apr. 20, 2016, the entire contents of which are incorporated herein by reference.

### FIELD

The embodiments discussed herein are related to a transmission device and a traffic control method.

### BACKGROUND

In a transmission device such as a layer 2 switch, for example, a field programmable gate array (FPGA) is widely used to execute transfer processing of packets. Along with the miniaturization of the process of the FPGA, a permissible value for a temporary reduction in power source voltage, that is, a permissible value of a voltage dip becomes small. For example, a permissible value of a voltage dip in a certain FPGA is 60 (mV) in the process of 45 (nm). However, the permissible value becomes 50 (mV) in the process of 40 (nm), and the permissible value becomes 28 (mV) in the process of 20 (nm).

The consumption current of the FPGA is changed depending on a packet rate. When the consumption current of the FPGA increases due to an increase in the packet rate, there is a case in which the power source voltage is reduced, and the voltage dip that exceeds the permissible value occurs.

In addition, for example, Japanese Laid-open Patent Publication No. 2008-72164 discusses that output of dummy data having a small difference with a variation of data in a time period in which there exists data is performed, in a time period in which there is no data, in order to suppress a fluctuation in the consumption current. Japanese Laid-open Patent Publication No. 2011-142567 discusses that a power source controls output voltage depending on a variation in current based on a traffic amount in order to maintain stable power source voltage.

However, in a technology discussed in Japanese Laid-open Patent Publication No. 2008-72164, output of dummy data is performed so as to simply track the variation of data, and an amount of the dummy data sharply increases due to a sharp increase of the variation, so that it is difficult to suppress a reduction in the power source voltage effectively. In addition, in the technology discussed in Japanese Laid-open Patent Publication No. 2011-142567, the power source controls the output voltage depending on a traffic amount, so that an operation of another device that receives power supply from the same power source may be adversely affected. Such a problem also occurs in another type of device that executes transfer processing of packets in addition to the FPGA. In view of the problems, it is desirable that a fluctuation in the power source voltage is suppressed effectively.

### SUMMARY

According to an aspect of the invention, a transmission device includes a plurality of devices through which a plurality of paths in the transmission device passes; and a processor included in a device among the plurality of devices, the processor configured to receive a first packet, measure a first transmission rate of the received packet, generate a second packet such that a total of the first transmission rate of the first packet and a second transmission rate of the second packet becomes a predetermined value, and output the generated second packet to a path through which the received packet has been transmitted, from among the plurality of paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a layer 2 switch;

FIG. 2 is a diagram illustrating an example of a change in consumption current of each FPGA, which corresponds to each transmission rate in a comparative example;

FIG. 3 is a diagram illustrating an example of a change in power source voltage of the FPGA, which corresponds to each of the transmission rates in the comparative example;

FIG. 4 is a configuration diagram illustrating an example of an insertion unit;

FIG. 5 is a diagram illustrating an example of formats of a user packet and a current adjustment packet;

FIG. 6 is a diagram illustrating a change in consumption current of the FPGA in each of the comparative example and an embodiment;

FIG. 7 is a diagram illustrating a change in consumption current of the FPGA when transmission rates of an input path and an output path are increased at the same time;

FIG. 8 is a diagram illustrating an example of a relationship between a slew rate and a variation a transmission rate of user packets;

FIG. 9 is a diagram illustrating an example of a change for a total time of the transmission rate of user packets and the transmission rate of current adjustment packets;

FIG. 10 is a configuration diagram illustrating an example of a discard unit;

FIG. 11 is a configuration diagram illustrating another example of the layer 2 switch;

FIG. 12 is a configuration diagram illustrating another example of the layer 2 switch;

FIG. 13 is a configuration diagram illustrating another example of the layer 2 switch; and

FIG. 14 is a flowchart illustrating an example of a traffic control method.

### DESCRIPTION OF EMBODIMENTS

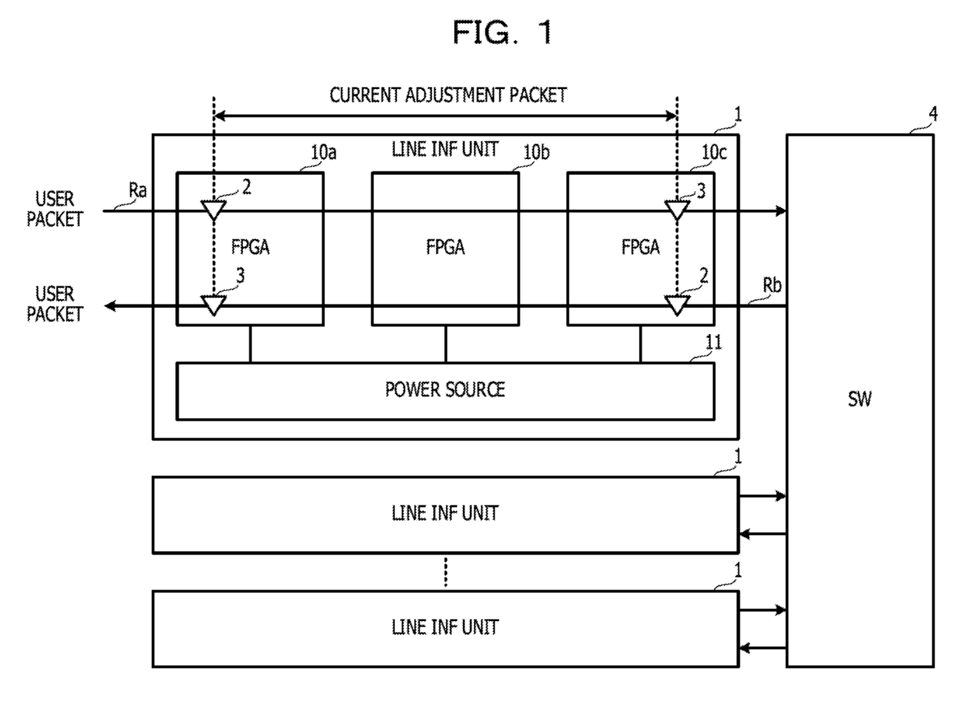

FIG. 1 is a configuration diagram illustrating an example of a layer 2 switch. The layer 2 switch is an example of a transmission device. The layer 2 switch includes a plurality of line interface units (line INF units) 1 and a switch unit (SW) 4. The transmission device is not limited to the layer 2 switch. For example, a router, a wavelength multiplexing transmission device, or the like is also an example of the transmission device.

The line INF unit 1 transmits and receives user packets that are main signals to and from another device through a communication line, and inputs and outputs user packets to and from the switch unit 4. The plurality of line INF units 1 exchanges user packets with the switch unit 4. That is, the switch unit 4 outputs a user packet that has been input from the line INF unit 1, to another line INF unit 1 corresponding to the destination. The user packet is an example of a packet transmitted to another device or a packet received from another device. The user packet has, for example, an Ethernet (registered trademark) frame. However, the user packet is not limited to the Ethernet frame.

The line INF units 1 and the switch unit 4 are accommodated in a slot provided on the front surface of a shelf that is housing. Each of the line INF units 1 and the switch unit 4 is a circuit board on which a plurality of electronic components is mounted. The line INF unit 1 and the switch unit 4 are electrically coupled to each other, for example, through a wiring board provided on the back surface of the shelf and connectors. The line INF unit 1 and the switch unit 4 communicate with each other through the wiring board.

The line INF unit 1 includes FPGAs 10a to 10c that are coupled to each other and a power source 11 are coupled to the FPGAs 10a to 10c. The power source 11 is, for example, an onboard power source, and supplies electric power used to drive each of the FPGAs 10a to 10c. That is, each of the FPGAs 10a to 10c is driven by the common power source 11. In the embodiment, as devices provided in the line INF unit 1, the FPGAs 10a to 10c are described. However, instead of the FPGAs 10a to 10c, another type of device such as a programmable logic device (PLD) may be used.

The line INF unit 1 receives a user packet from another device, and executes certain processing related to transfer of the user packet through the FPGAs 10a to 10c and outputs the user packet to the switch unit 4. The received user packet is transmitted through an input path Ra that passes through the FPGAs 10a to 10c in such order, and is output to the switch unit 4.

In the line INF unit 1, a user packet is input from the switching unit 4, is subject to certain processing related to transfer of the user packet through the FPGAs 10a to 10c, and is transmitted to another device. The input user packet is transmitted along an output path Rb that passes through the FPGAs 10c, 10b, and 10a in such order and is output to another device. The input path Ra is an example of a first path. The output path Rb is an example of a second path.

The consumption current of each of the FPGAs 10a to 10c is changed depending on a transmission rate of user packets. When the consumption current of each of the FPGAs 10a to 10c increases with an increase of the transmission rate of the user packets, there is a case in which the voltage of the power source 11 drops, and a voltage dip occurs that exceeds a permissible value.

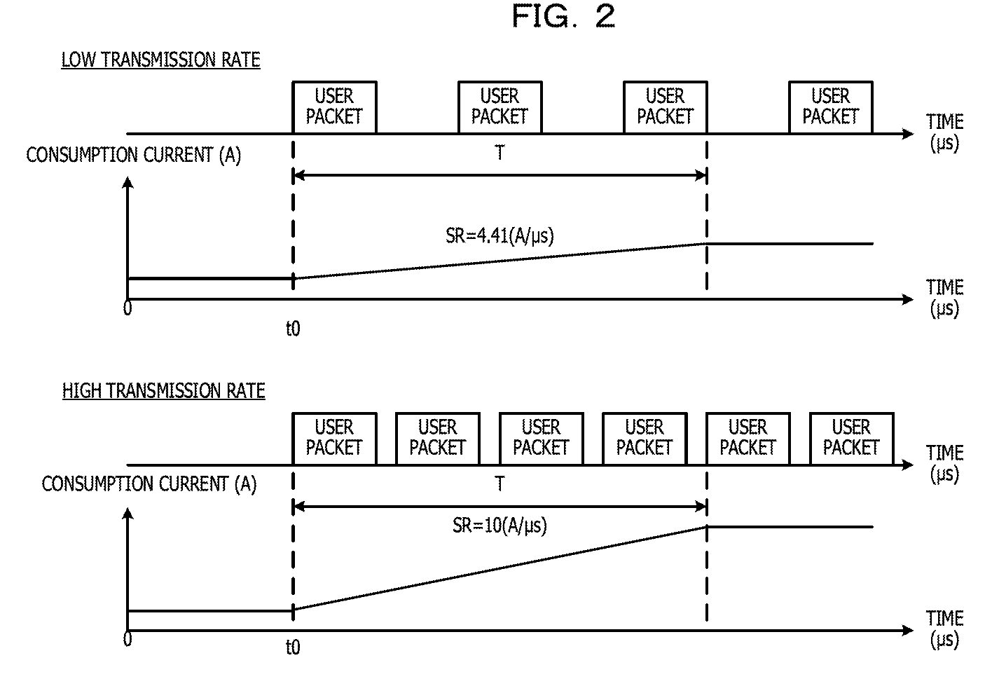

FIG. 2 is a diagram illustrating an example of a change in consumption current of each of the FPGAs 10a to 10c, which corresponds to each transmission rate in a comparative example. FIG. 2 illustrates a change in the consumption current and the number of user packets to time in a case in which the transmission rate of the user packets is low (see “low transmission rate”) and a change in the consumption current and the number of user packets to a time in a case in which the transmission rate of the user packets is high (see “high transmission rate”).

In FIG. 2, a time t0 indicates a time at which a user packet starts to be input to the FPGAs 10a to 10c. A time period T indicates a taken time period in which the user packet passes through the FPGAs 10a to 10c, that is, a delay time (latency) due the FPGAs 10a to 10c. A slew rate “SR” indicates a change amount of the consumption current in a unit of time (1 (μs) in this example), that is, an increase rate to time.

In this example, an increase in the consumption current of each of the FPGAs 10a to 10c when the state in which transmission of user packets is yet to be performed transitions to the state in transmission of user packets is performed is described. However, in the following description, a case is also applied in which the consumption current changes when the transmission rate has increased during transmission of user packets.

The consumption current of each of the FPGAs 10a to 10b starts to increase when the user packet starts to be input. In addition, the consumption current of each of the FPGAs 10a to 10b becomes a fixed value when the first initial user packet is output from the FPGAs 10a to 10c. When the transmission rate of the user packets is high, the number of user packets that pass through the FPGAs 10a to 10b is larger than that of a case in which the transmission rate of the user packets is low. Therefore, when the transmission rate of the user packets is high, the slew rate has a larger than that of the case in which the transmission rate of the user packets is low.

In this example, when the transmission rate is low, the slew rate is 4.41 (A/μs), but when the transmission rate is high, the slew rate is 10 (A/μs). Here, each of the FPGAs 10a to 10c is a device that has been manufactured in accordance with a rule of a wiring width of 20 (nm). Due to an increase in the consumption current, large voltage is drawn from the power source 11 to each of the FPGAs 10a to 10c, so that the voltage of the power source 11 is reduced.

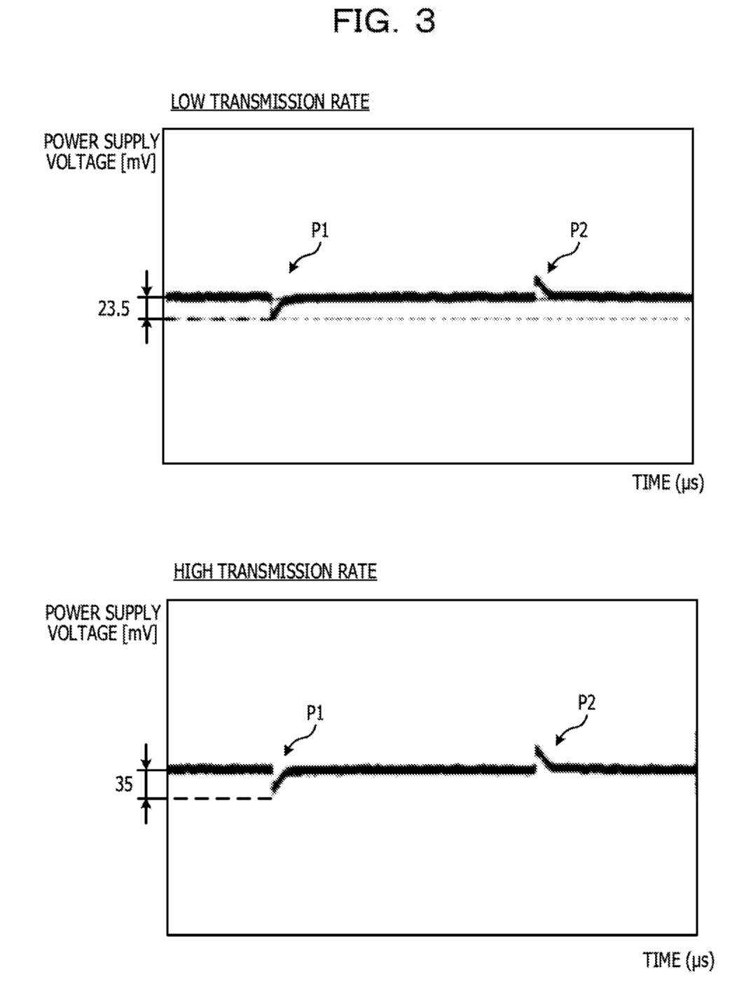

FIG. 3 is a diagram illustrating an example of a change in power source voltage of each of the FPGAs 10a to 10c, which correspond to each of the transmission rates in the comparative example. Correspondingly to FIG. 2, FIG. 3 illustrates the voltage of the power source 11 when the transmission rate of the user packets is low (see “low transmission rate”) and the voltage of the power source 11 when the transmission rate of the user packets is high (see “high transmission rate”).

In FIG. 3, a symbol P1 represents a voltage dip due to an increase in the consumption current. A symbol P2 represents a temporary increase of voltage due to stop of the increase in the consumption current (hereinafter referred to as “voltage increase”). The voltage dip P1 occurs at the time of the increase start of the consumption current, that is, at the time t0 of FIG. 2. The voltage increase P2 occurs at the time of the increase stop of the consumption current, that is, at the time t0+T of FIG. 2. Each of the voltage dip P1 and the voltage increase P2 becomes larger as the slew rate of the consumption current increases.

The permissible value of the voltage dip P1 is defined as a recommended operation condition of each of the FPGAs 10a to 10c. In a case of the FPGAs 10a to 10c in the process of 20 (nm), the permissible value of the voltage dip P1 becomes 28 (mV). Therefore, when the permissible value of the voltage dip P1 exceeds 28 (mV), a failure may occur in the operation of the FPGAs 10a to 10c.

A value of the voltage dip P1 in the case of the low transmission rate (SR=4.41 (A/μs)) is 23.5 (mV), and becomes smaller than 28 (mV) that is the permissible value. Therefore, a failure does not occur in the operation of the FPGAs 10a to 10c. However, a value of the voltage dip P1 in the case of the high transmission rate (SR=10 (A/μs)) is 35 (mV), and larger than 28 (mV) that is the permissible value. Therefore, a failure may occur in the operation of the FPGAs 10a to 10c. Similar to the voltage dip P1, in the voltage increase P2, when an increase amount in the power source voltage is large, a failure may occur in the operation of the FPGAs 10a to 10c.

Therefore, in the embodiment, in order to reduce a fluctuation in the voltage of the power source 11, a current adjustment packet is transmitted to each of the FPGAs 10a to 10c so that the slew rate of the consumption current is reduced. Even when the transmission rate of the user packets is low, the consumption current is raised as long as a total of the transmission rate of the user packets and the transmission rate of the current adjustment packets is kept at a certain value by the current adjustment packets. Therefore, even when the transmission rate of the user packets increases, an increase amount of the consumption current of each of the FPGAs 10a to 10c may be limited. As a result, the slew rate of the consumption current is reduced, so that a fluctuation in the voltage of the power source 11 is reduced.

Returning to FIG. 1, the line INF unit 1 includes a pair of an insertion unit 2 and a discard unit 3 that execute processing of current adjustment packets in each of the input path Ra and the output path Rb. In the FPGA 10a, the insertion unit 2 is provided that inserts a current adjustment packet into the input path Ra. In the FPGA 10c, the discard unit 3 is provided that detects and discards a current adjustment packet on the input path Ra. In the FPGA 10c, the insertion unit 2 is provided that inserts a current adjustment packet into the output path Rb. In the FPGA 10a, the discard unit 3 is provided that detects and discards a current adjustment packet on the output path Rb.

Therefore, a current adjustment packet is transmitted and received between the insertion unit 2 and the discard unit 3 in each of the input path Ra and the output path Rb. As a result, the consumption current of each of the FPGAs 10a to 10c is adjusted so that the slew rate is reduced.

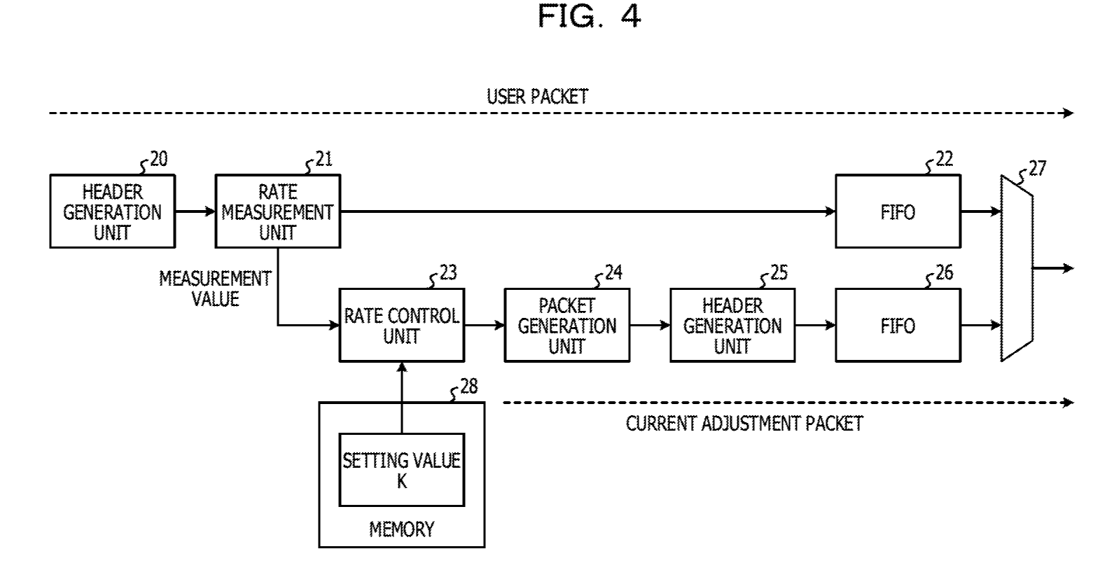

FIG. 4 is a configuration diagram illustrating an example of the insertion unit 2. The insertion unit 2 includes header generation units 20 and 25, a rate measurement unit 21, first-in first-out (FIFO) 22 and 26, a rate control unit 23, a packet generation unit 24, a multiplexer 27, and a memory 28.

A user packet passes through the header generation unit 20, the rate measurement unit 21, and the FIFO 22 in such order. A current adjustment packet passes through the packet generation unit 24, the header generation unit 25, and the FIFO 26 in such order.

The header generation unit 20 generates an in-device header, and assigns the header to the user packet. The in-device header of the user packet includes, for example, information such as an identifier and a destination of the user packet. The header generation unit 20 outputs the user packet to which the in-device header has been assigned, to the rate measurement unit 21.

The rate measurement unit 21 is an example of a measurement unit, and measures the transmission rate of the user packets. More specifically, the rate measurement unit 21 measures the flow rate of the user packets, that is, the effective number of bytes of the user packets that have passed per unit of the time.

The transmission rate that has been measured by the rate measurement unit 21 is different depending on a transmission direction. In the case of the insertion unit 2 on the input path Ra, the rate measurement unit 21 measures the transmission rate of user packets received from another device. In the case of the insertion unit 2 on the output path Rb, the rate measurement unit 21 measures the transmission rate of user packets transmitted to another device.

The user packets that pass through the rate measurement unit 21 are input to the FIFO 22. The FIFO 22 stores the plurality of user packets. The FIFO 22 outputs the user packets to the multiplexer 27, in accordance with the storage order.

The packet generation unit 24 is an example of a generation unit, and generates a current adjustment packet. The current adjustment packet is an example of a dummy packet. The generated current adjustment packet is output to the packet generation unit 24. The header generation unit 25 generates an in-device header and assigns the header to the current adjustment packet. The in-device header of the current adjustment packet includes, for example, information such as an identifier of the current adjustment packet.

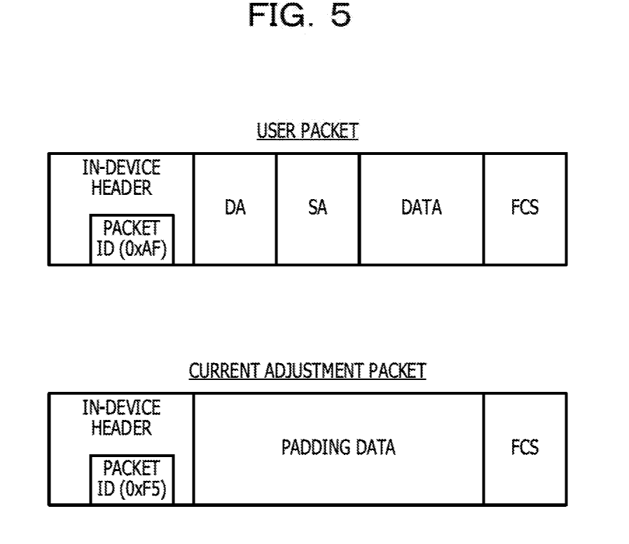

FIG. 5 is a diagram illustrating an example of formats of a user packet and a current adjustment packet. The user packet includes an in-device header, a destination address (DA) indicating the destination, a source address (SA) indicating the transmission source, data, and a frame check sequence (FCS) that is an error correction symbol. The current adjustment packet includes, an in-device header, padding data having, for example, a certain pattern, and an FCS.

The in-device header includes a packet ID that is an identifier of the packet. The packets ID of the user packet and the current adjustment packet are respectively set at different values. As an example, the packet ID of the current adjustment packet is set at 0xAF (0x indicates a hexadecimal). The packet ID of the user packet is set at 0xF5. Therefore, the user packet and the current adjustment packet may be distinguished by the respective packet IDs.

Returning to FIG. 4, the packet generation unit 24 outputs the current adjustment packet to which the in-device header has been assigned, to the FIFO 26. The FIFO 26 stores the plurality of current adjustment packets. The FIFO 26 outputs the current adjustment packets, to the multiplexer 27 in accordance with the storage order.

The multiplexer 27 is an example of an output unit, and outputs the current adjustment packet to the path common with the user packet. More specifically, the multiplexer 27 reads the user packet from the FIFO 22 that is one of the FIFO and reads the current adjustment packet from the FIFO 26 that is the other FIFO. At this time, the multiplexer 27 may read the user packet and the current adjustment packet in accordance with a round robin scheme so as to be fair for the two FIFOs 22 and 26. Alternatively, the multiplexer 27 may read the user packet in preference to the current adjustment packet, in accordance with a certain algorithm.

The multiplexer 27 multiplies the read user packet and the read current adjustment packet and outputs the multiplied packets. As a result, the multiplexer 27 outputs the current adjustment packet to the path common with the user packet in the line INF unit 1.

For example, in the FPGA 10a, the multiplexer 27 outputs the current adjustment packet to the input path Ra. Here, the path from the header generation unit 25 to the FIFO 26 is a part of the input path Ra. In the FPGA 10c, the multiplexer 27 outputs the current adjustment packet to the output path Rb. Here, the path from the header generation unit 25 to the FIFO 26 is a part of the output path Rb.

As described above, the current adjustment packet is transmitted along the same path as the user packet in the line INF unit 1.

The rate measurement unit 21 notifies the rate control unit 23 of a measurement value of the transmission rate of the user packets. The rate control unit 23 is an example of a control unit. The rate control unit 23 controls the packet generation unit 24 so that a total of the transmission rate that has been measured by the rate measurement unit 21 and the transmission rate of the current adjustment packets becomes a certain setting value K. The setting value K is stored, for example, in the memory 28. The rate control unit 23 reads the setting value K from the memory 28.

More specifically, the rate control unit 23 controls the data length of the current adjustment packet generated by the packet generation unit 24 (for example, the length of padding data) so that the transmission rate of the current adjustment packets in the line INF unit 1 becomes a value that has been obtained by subtracting the measurement value of the rate measurement unit 21 from the setting value K. In the following description, the transmission rate is represented by a percentage (%) of the maximum value of the transmission rate of the line INF unit 1 (hereinafter referred to as “full rate”), and an example of the transmission rate is described.

For example, when it is assumed that the measurement value of the rate measurement unit 21 is 40(%), and the setting value K is 60(%), the rate control unit 23 calculates the transmission rate of the current adjustment packets as 20(%) (=60-40). At this time, the packet generation unit 24 generates current adjustment packets so that the transmission rate of the current adjustment packets becomes 20(%).

For example, when it is assumed that the measurement value of the rate measurement unit 21 is 10(%), and the setting value K is 60(%), the rate control unit 23 calculates the transmission rate of the current adjustment packet as 50(%) (=60-10). At this time, the packet generation unit 24 generates current adjustment packets so that the transmission rate of the current adjustment packets becomes 10(%).

As described above, the rate control unit 23 controls generation of current adjustment packets so that the transmission rate of the user packets and the transmission rate of the current adjustment packets become the certain setting value K. The current adjustment packet is output to the input path Ra or the output path Rb common with the user packet by the multiplexer 27.

Therefore, when the transmission rate of the user packets is smaller than the setting value K, the consumption current of each of the FPGAs 10a to 10c increases due to transmission processing of current adjustment packets, and is maintained to be fixed based on the setting value K.

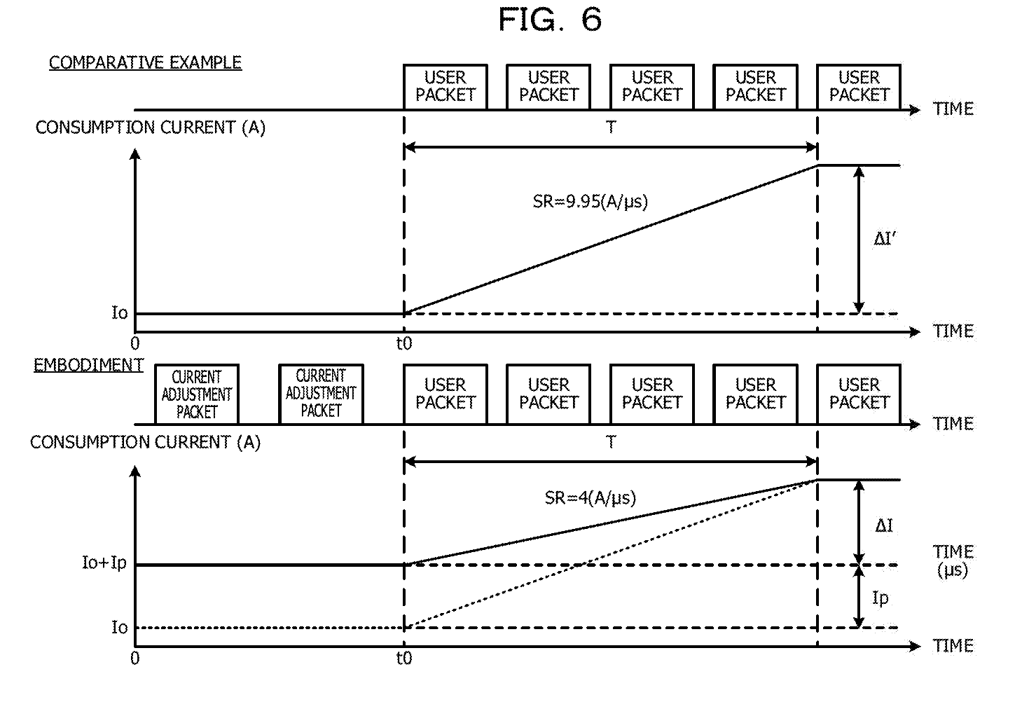

FIG. 6 is a diagram illustrating a change in consumption current of each of the FPGAs 10a to 10c each of in the comparative example and the embodiment. In FIG. 6, the same symbol is assigned to a parameter common with FIG. 2, and the description is omitted herein. In this example, an increase in the consumption current of each of the FPGAs 10a to 10c when the state in which transmission of the user packet is yet to be performed transitions to the state in which transmission of the user packet is performed is described as an example. However, in the following description, a case is also applied in which the consumption current changes when the transmission rate has increased during transmission of the user packet.

Here, AI′ indicates an increase amount of consumption current in the time period T in the comparative example. In addition, AI indicates an increase amount of consumption current in the time period T in the embodiment. In addition, “Io” indicates the consumption current in a time period from the time 0 to a time t0 in the comparative example. In addition, “Ip” indicates an increase portion from the consumption current of Io due to the transmission of the current adjustment packets in the time period from the time 0 to the time t0 in the embodiment. On the graph of the consumption current in the embodiment, the consumption current in the comparative example is represented by the dotted line.

In the comparative example, transmission of user packets is not performed in the time period from the time 0 to the time t0, so that the consumption current Io of each of the FPGAs 10a to 10c becomes small. Therefore, the increase amount AI′ of the consumption current in the time period T becomes large, and the slew rate becomes high. At this time, when it is assumed that the transmission rate of the user packets in the time period t0 or later is the full rate, the slew rate becomes, for example, 9.95 (A/μs).

On the other hand, in the embodiment, transmission of current adjustment packets is performed at the transmission rate based on the setting value K in the time period from the time 0 to the time t0, so that the consumption current of each of the FPGAs 10a to 10c becomes large by “Ip” as compared with the comparative example. That is, the consumption current becomes “Io+Ip”. Therefore, the increase amount AI of the consumption current in the time period T is small as compared with the comparative example, and the slew rate is also reduced as compared with the comparative example. At this time, when it is assumed that the transmission rate of the user packets in the time period t0 or later is the full rate, the slew rate becomes, for example, 4 (A/μs).

As described above, in the embodiment, the consumption current of each of the FPGAs 10a to 10c increases due to the transmission of the current adjustment packets, and is maintained at an approximately fixed value. Thus, even when the transmission rate of the user packets increases, as described below, an increase amount of the transmission rate of the user packets is limited at a certain value or less when an appropriate setting value K is set, and an increase amount of the consumption current may be suppressed so that the voltage dip does not exceed the permissible value.

The setting value K is determined, for example, when a range of the slew rate in which the voltage dip becomes the permissible value or less is measured based on the permissible value of the voltage dip, which has been defined as a recommended operation condition of each of the FPGAs 10a to 10c, and a transmission rate range corresponding to such a range is identified. In this example, on the premise that the FPGAs 10a to 10c are manufactured in accordance with the process rule of 20 (nm), it is assumed that the permissible value of the voltage dip is 28 (mV), and the slew rate range in which the voltage dip becomes 28 (mV) or less is 4 (A/μs) or less.

The transmission rate range in which the slew rate becomes 4 (A/μs) or less is identified when a change in the slew rate of the consumption current for the increase amount of the transmission rate is measured. At this time, the slew rate is measured from the change in the consumption current of each of the FPGAs 10a to 10c when the transmission rate of the input path Ra and the transmission rate of the output path Rb are increased at the same time.

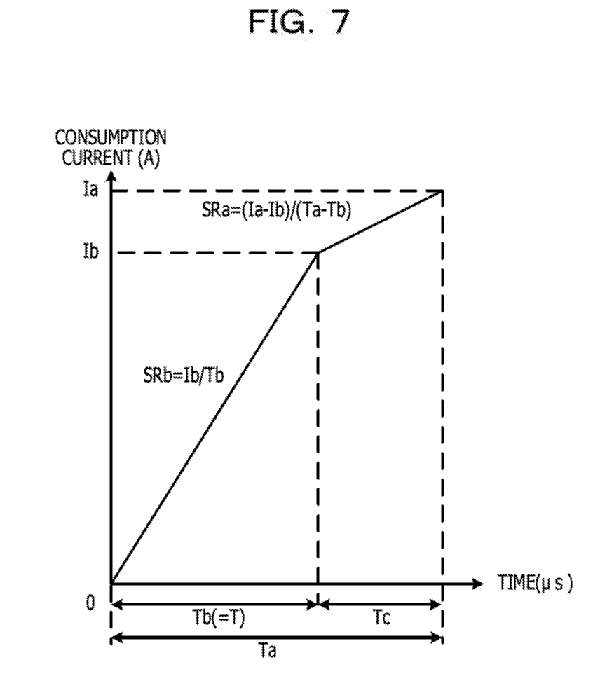

FIG. 7 is a diagram illustrating a change in the consumption current of each of the FPGAs 10a to 10c when the transmission rate of the input path Ra and the transmission rate of the output path Rb are increased at the same time. In FIG. 7, the horizontal axis indicates an elapsed time (μs) from the start of input of user packets to the FPGAs 10a to 10c in both of the directions of the input path Ra and the output path Rb at the same time. The vertical axis indicates a change in the consumption current of each of the FPGAs 10a to 10c.

A time period Ta indicates a time period (delay time) taken when the user packets pass through the FPGAs 10a to 10c along the input path Ra. A time period Tb indicates a time taken when the user packets pass through the FPGAs 10a to 10c along the output path Rb. A time period Tc indicates a time after the time period Tb has elapsed, during the time period Ta. In addition, “SRa” indicates the slew rate in the time period Ta. In addition, “SRb” indicates the slew rate in the time period Tc.

SRa=(Ia−Ib)/Tc=(Ia−Ib)/(Ta−Tb) (1)

SRb=Ib/Tb (2)

When it is assumed that the consumption current after the time period Ta has elapsed is “Ia”, and the consumption current after the time period Tb has elapsed is “Ib”, the slew rate SRa of the time period Tc is calculated by the above-described formula (1). In addition, the slew rate SRb of the time period Tb is calculated by the above-described formula (2). In the time period Tb, user packets are transmitted in both of the directions of the input path Ra and the output path Rb. In the time period Tc, user packets are transmitted merely in the direction of the input path Ra. Therefore, the slew rate SRb of the time period Tb is larger than the slew rate SRa of the time period Tc.

Thus, the transmission rate range in which the slew rate becomes 4 (A/μs) or less is identified when a change in the slew rate SRb of the consumption current for an increase amount of the transmission rate is measured. The time period T illustrated in FIGS. 2 and 6 matches the above-described time period Tb.

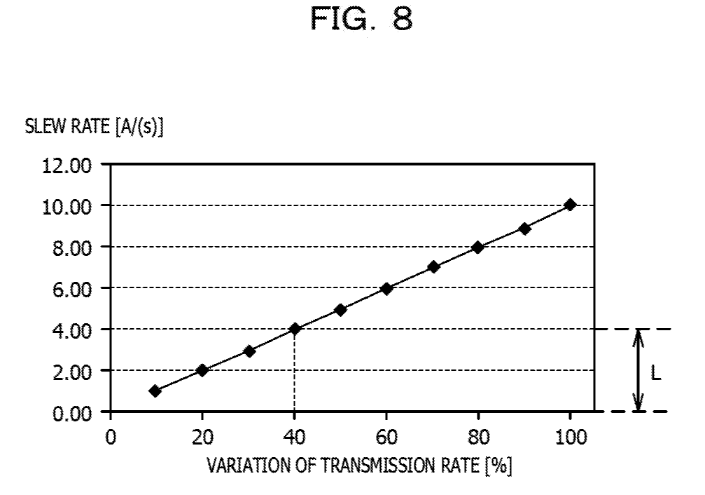

FIG. 8 is a diagram illustrating an example of a relationship between a slew rate SRb and a variation of the transmission rate of user packets. In FIG. 8, the horizontal axis indicates a variation (%) of the transmission rate of the input path Ra and the output path Rb when it is assumed that the full rate is 100(%). The vertical axis indicates the slew rate (A/μs) of the consumption current of each of the FPGAs 10a to 10c.

That is, FIG. 8 illustrates the slew rate SRb for an increase portion of the transmission rate. For example, when the transmission rate increases by 20(%) of the full rate, the slew rate SRb becomes 1.99 (A/μs). When the transmission rate increases by 100(%) of the full rate, that is, when the state in which transmission of user packets is not performed transitions to the state in which transmission of user packets is performed at the full rate, as illustrated in the example of FIG. 6, the slew rate SRb becomes 9.95 (A/μs).

Based on the measurement result illustrated in FIG. 8, the transmission rate range L in which the slew rate SRb becomes 4 (A/μs) or less is determined to be 0 to 40(%). Thus, the setting value K is determined to be 60(%) that has been obtained by subtracting 40(%) that is the maximum value of the range L from the full rate (100(%)).

When the setting value K that has been determined as described above is set to the memory 28, an increase amount of the transmission rate of the user packets may be limited to a certain value or less. The setting value K in the memory 28 may be changed, for example, through an external device such as a network management device.

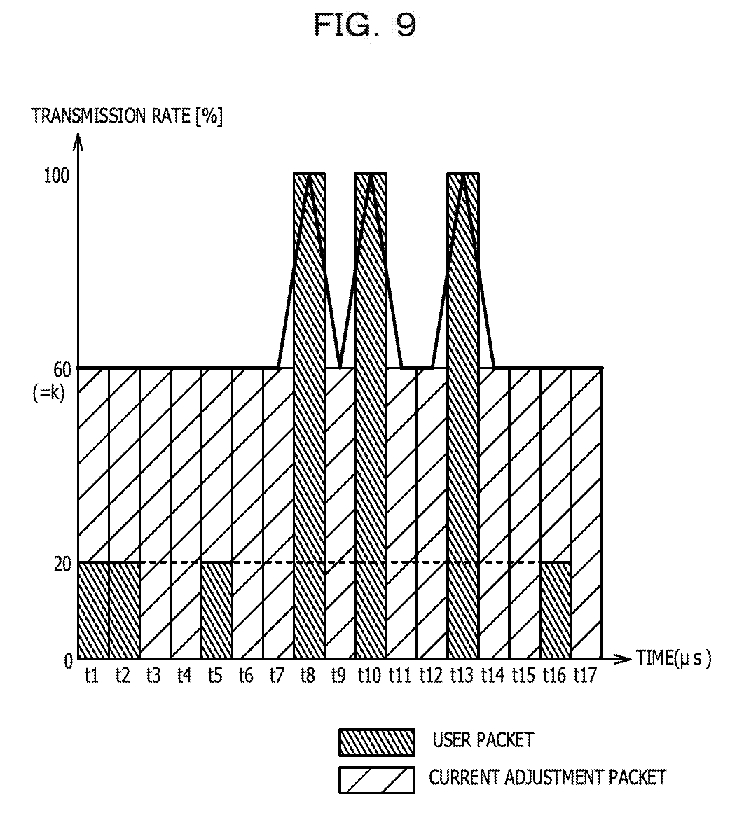

FIG. 9 is a diagram illustrating an example of a change for a total time of the transmission rate of user packets and the transmission rate of current adjustment packets. In FIG. 9, the horizontal axis indicates a time (μs). The vertical axis indicates a total of the transmission rate of the user packets and the transmission rate of the current adjustment packets (see the polyline). In FIG. 9, a breakdown of the transmission rate of the user packets and the transmission rate of the current adjustment packets in the unit of time (t1 to t17) is indicated by different hatching areas.

In this example, it is assumed that the setting value K is set at 60(%). Therefore, the rate control unit 23 illustrated in FIG. 2 controls the packet generation unit 24 so that the total of the transmission rate of the user packets and the transmission rate of the current adjustment packets becomes 60(%).

For example, at times t1, t2, t5, and t16, the transmission rate of the user packet is 20(%). Therefore, the rate control unit 23 controls the packet generation unit 24 so that the transmission rate of the current adjustment packets becomes 40(%) (=60−20), based on the measurement value 20(%) of the rate measurement unit 21.

At times t3, t4, t6, t7, t9, t11, t12, t14, t15, and t17, the transmission rate of the user packets is 0(%). Therefore, the rate control unit 23 controls the packet generation unit 24 so that the transmission rate of the current adjustment packets becomes 60(%) (=60−0), based on the measurement value 0(%) of the rate measurement unit 21.

As described above, the rate control unit 23 maintains the total of the transmission rate of the user packets and the transmission rate of the current adjustment packets at 60(%). Therefore, at times t8, t10, and t13, even when the transmission rate of the user packets increases, the maximum value of the increase amount is limited to 40(%) (=100−60).

Thus, a fluctuation in the power source voltage is reduced effectively because the slew rate of the consumption current is reduced so that the voltage dip does not exceed the permissible value. As a result, in addition to the voltage dip P1 of FIG. 3, the voltage increase P2 is also reduced.

When the transmission rate that has been measured by the rate measurement unit 21 is a certain value or more, the rate control unit 23 controls the packet generation unit 24 so that generation of current adjustment packets is suspended. More specifically, at the times t8, t10, and t13, the measurement value of the rate measurement unit 21 is 100(%) that exceeds the setting value K (=60(%)). Therefore, the rate control unit 23 instructs the packet generation unit 24 to suspend the generation of a current adjustment packet. As a result, for example, it is avoided that a user packet is discarded by the multiplexer 27 due to excess of the transmission rate.

As described above, a current adjustment packet is discarded by the discard unit 3 of FIG. 1. Therefore, it is avoided that a current adjustment packet is transmitted to another device through the communication line.

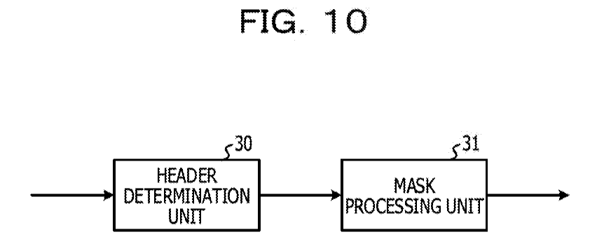

FIG. 10 is a configuration diagram illustrating an example of the discard unit 3. The discard unit 3 includes a header determination unit 30 and a mask processing unit 31.

The header determination unit 30 determines contents of the in-device headers of a user packet and a current adjustment packet. More specifically, the header determination unit 30 detects the user packet and the current adjustment packet, based on packet IDs of the in-device headers. When the current adjustment packet has been detected, the header determination unit 30 notifies the mask processing unit 31 of the information indicating that the current adjustment packet has been detected.

The mask processing unit 31 executes mask processing of the current adjustment packet, in accordance with the notification from the header determination unit 30. As a result, the current adjustment packet is discarded so as not to be output from the mask processing unit 31 to the subsequent stage.

In the embodiment, the insertion unit 2 is provided in each of the FPGA 10a through which the input path Ra passes first and the FPGA 10c through which the output path Rb passes first. The discard unit 3 is provided in each of the FPGA 10c through which the input path Ra eventually passes and the FPGA 10a through which the output path Rb passes last.

Thus, the slew rate of the consumption current may be reduced over all of the FPGAs 10a to 10c through which the input path Ra and the output path Rb pass. The embodiment is not limited to such installation examples of the insertion unit 2 and the discard unit 3.

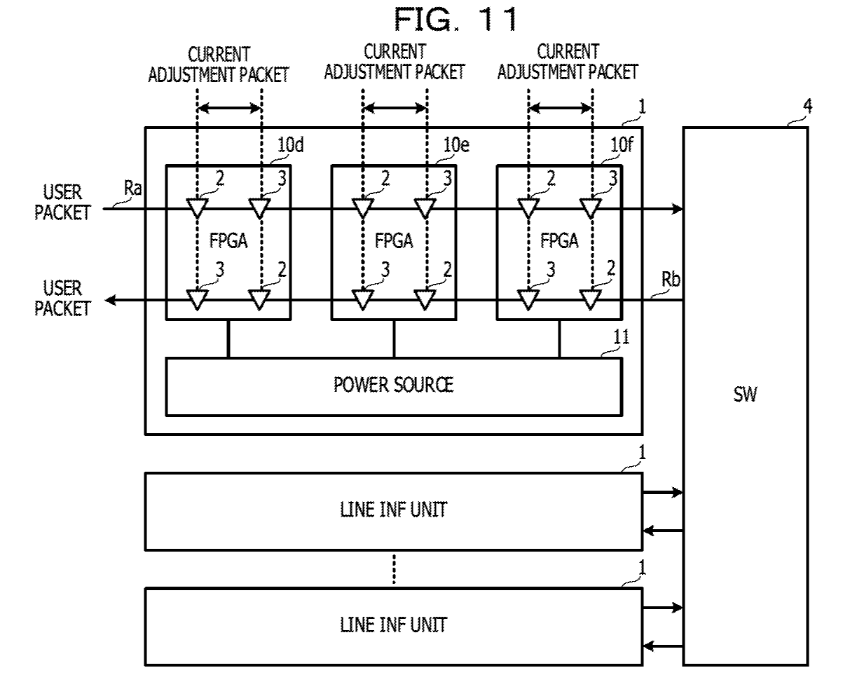

FIG. 11 is a configuration diagram illustrating another example of the layer 2 switch. In FIG. 11, the same symbol is assigned to a common configuration with FIG. 1, and the description is omitted herein.

In a line INF unit 1, FPGAs 10d to 10f and a power source 11 that supplies electric power to the FPGAs 10d to 10f are provided. A user packet that has been received from another device to the line INF unit 1 is transmitted along an input path Ra that passes through the FPGAs 10d to 10f in such order and is output to a switch unit 4. A user packet input from the switch unit 4 to the line INF unit 1 is transmitted along an output path Rb that passes through FPGAs 10f, 10e, and 10d in such order.

In each of the FPGAs 10d to 10f, an insertion unit 2 and a discard unit 3 are provided along each of the input path Ra and the output path Rb. Therefore, for example, even when the transmission rate is different for each of the FPGAs 10d to 10f due to discard processing, duplication processing, and the like, of the user packet, the slew rate of the consumption current may be reduced appropriately based on the setting value K for each of the FPGAs 10d to 10f.

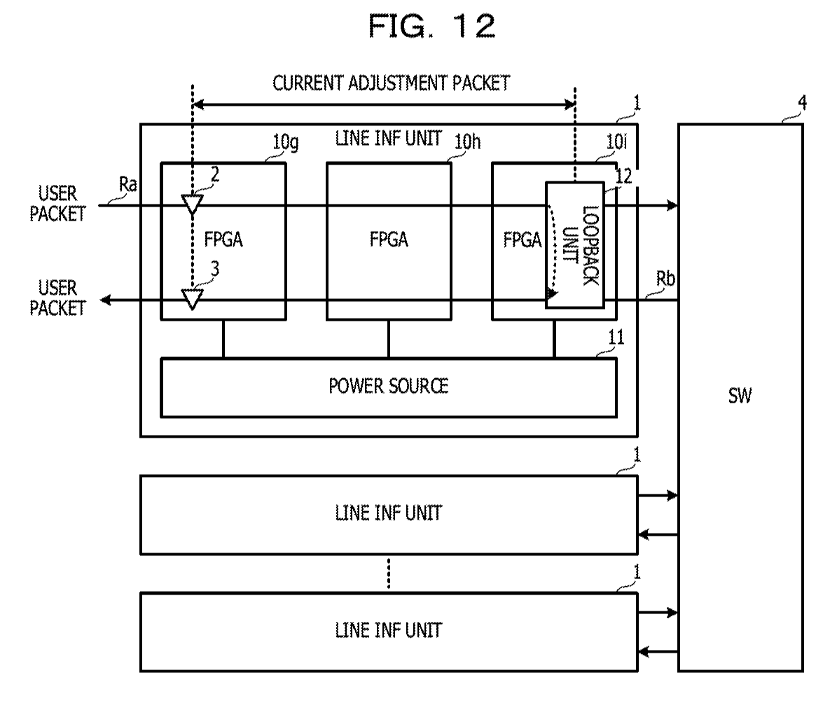

FIG. 12 is a configuration diagram illustrating another example of the layer 2 switch. In FIG. 12, the same symbol is assigned to a common configuration with FIG. 1, and the description is omitted herein.

In a line INF unit 1, FPGAs 10g to 10i and a power source 11 that supplies electric power to the FPGAs 10g to 10i are provided. A user packet that has been received from another device to the line INF unit 1 is transmitted along an input path Ra that passes through the FPGAs 10g to 10i in such order and is output to a switch unit 4. A user packet that has been input from the switch unit 4 to the line INF unit 1 is transmitted along an output path Rb that passes through the FPGAs 10i, 10h, and 10g in such order.

In the FPGA 10g corresponding to one end of each of the input path Ra and the output path Rb, an insertion unit 2 and a discard unit 3 are provided. More specifically, in the FPGA 10g, the insertion unit 2 is provided on the input path Ra. In addition, the discard unit 3 is provided on the output path Rb.

In the FPGA 10i corresponding to the other end of each of the input path Ra and the output path Rb, a loopback unit 12 that loops back a current adjustment packet from the input path Ra to the output path Rb. The loopback unit 12 detects a current adjustment packet on the input path Ra using a packet ID of the in-device header, and outputs the current adjustment packet to the output path Rb.

Therefore, after the current adjustment packet has been inserted into the input path Ra at the FPGA 10g, the current adjustment packet is input to the FPGA 10i through the FPGA 10h. In addition, the current adjustment packet is input to the FPGA 10g through the FPGA 10h again and discarded.

In this example, the insertion unit 2 and the discard unit 3 are provided merely in the FPGA 10g. Therefore, as compared with the embodiment of FIG. 1, the circuit scale is reduced. The loopback unit 12 may be provided in the switch unit 4.

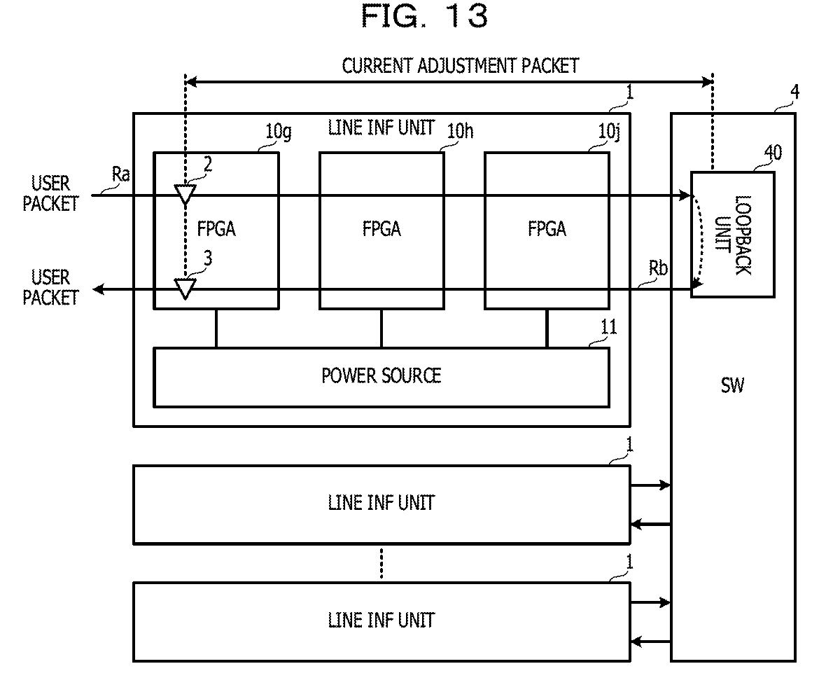

FIG. 13 is a configuration diagram illustrating another example of the layer 2 switch. In FIG. 13, the same symbol is assigned to a common configuration with FIG. 12, and the description is omitted herein.

In a line INF unit 1, FPGAs 10g, 10h, and 10j and a power source 11 that supplies electric power to the FPGAs 10g, 10h, and 10j. A user packet that has been received from another device to the line INF unit 1 is transmitted along an input path Ra that passes through the FPGAs 10g, 10h, and 10j in such order and is output to a switch unit 4. A user packet that has been input from the switch unit 4 to the line INF unit 1 is transmitted along an output path Rb that passes through the FPGAs 10j, 10h, and 10g in such order.

In the switch unit 4, a loopback unit 40 that loops back a current adjustment packet from the input path Ra to the output path Rb is provided. Therefore, after the current adjustment packet has been inserted into the input path Ra at the FPGA 10g, the current adjustment packet is input to the switch unit 4 through the FPGAs 10h and 10j. In addition, the current adjustment packet is input to the FPGA 10g through the FPGAs 10h and 10j again and discarded. Thus, even in this example, the circuit scale may be reduced similar to the example of FIG. 12.

A traffic control method executed by the above-described layer 2 switches is described below.

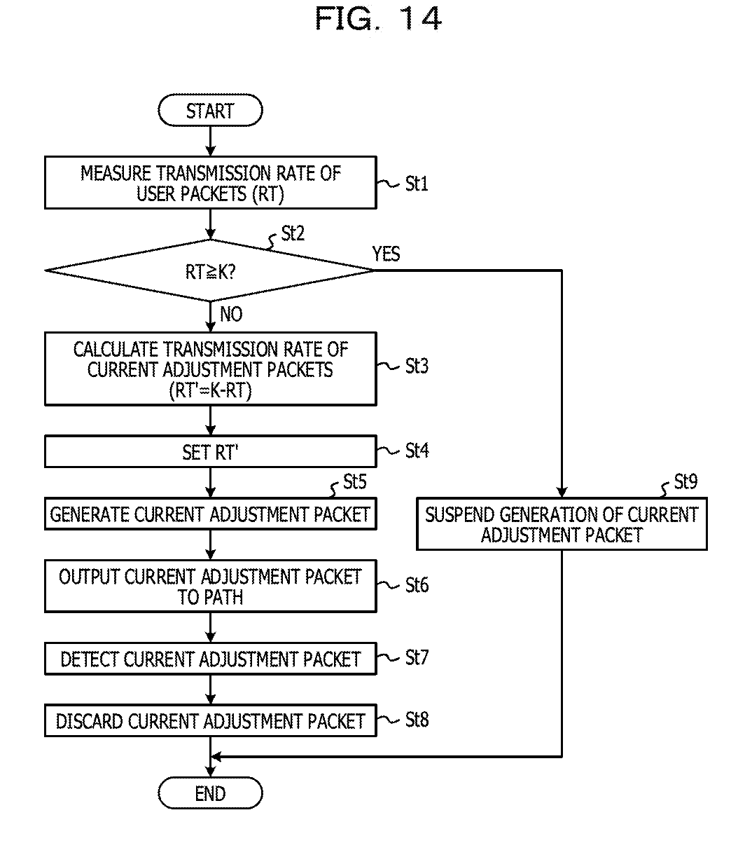

FIG. 14 is a flowchart illustrating an example of the traffic control method. The traffic control method is executed, for example, at certain intervals.

The rate measurement unit 21 measures a transmission rate RT of user packets (St1). Next, the rate control unit 23 compares the transmission rate RT with the setting value K that has been read from the memory 28 (St2).

When “RT≧K” is satisfied (Yes in St2), the rate control unit 23 controls the packet generation unit 24 so as to suspend generation of a current adjustment packet (St9). That is, the packet generation unit 24 suspends the generation of a current adjustment packet when the transmission rate RT that has been measured by the rate measurement unit 21 is the setting value K or more.

When “RT<K” is satisfied (No in St2), the rate control unit 23 calculates a transmission rate RT′ of current adjustment packets (St3). The transmission rate RT′ of the current adjustment packets is calculated by subtracting the transmission rate RT of the user packets from the setting value K.

Next, the rate control unit 23 sets the transmission rate RT′ of the current adjustment packets to the packet generation unit 24 (St4). Next, the packet generation unit 24 generates a current adjustment packet in accordance with the transmission rate RT′ of the current adjustment packets (St5).

As described above, the rate control unit 23 controls generation of a current adjustment packet so that a total of the transmission rate RT that has been measured by the rate measurement unit 21 and the transmission rate RT′ of the current adjustment packets becomes the certain setting value K.

Next, the multiplexer 27 outputs the current adjustment packet to a path common with the user packet, that is, the input path Ra or the output path Rb (St6). As a result, the current adjustment packet is transmitted through the input path Ra or the output path Rb with the user packet.

Next, the header determination unit 30 detects the current adjustment packet on the input path Ra or the output path Rb using the packet ID of the in-device header (St7). Next, the mask processing unit 31 discards the current adjustment packet by mask processing (St8). As described above, the traffic control method is executed.

In the traffic control method in the example, as described above, a fluctuation in the power source voltage is reduced effectively because the slew rate of the consumption current is reduced so that the voltage dip does not exceed the permissible value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a plurality of devices through which a plurality of paths in the transmission device passes; and
a processor included in a device among the plurality of devices, the processor configured to:
receive a first packet,
measure a first transmission rate of the received first packet,
generate a second packet such that a total of the first transmission rate of the first packet and a second transmission rate of the second packet becomes a predetermined value, and
output the generated second packet to a path through which the received first packet has been transmitted, from among the plurality of paths.

2. The transmission device according to claim 1,
wherein the processor is configured to discard the second packet when the second packet is detected on the path.

3. The transmission device according to claim 1,
wherein the processor is configured to suspend generation of the second packet when the measured transmission rate is the predetermined value or more.

4. The transmission device according to claim 1,
wherein the device is a device that is at a first stage through which the received packet passes first in the transmission device.

5. The transmission device according to claim 2,
wherein the processor is a processor included in each of the plurality of devices.

6. The transmission device according to claim 2, further comprising
a switch coupled to a device that is at a last stage from among the plurality of devices, wherein
the processor is included in a device that is at a first stage from among the plurality of devices,
the plurality of paths includes a first path and a second path having different transmission directions,
the switch loops back the first packet that has been received at the first path to the second path, and
the processor discards the second packet when the second packet is detected on the second path.

7. A transmission method executed by a processor included in a device from among a plurality of devices through which a plurality of paths pass in a transmission device, the transmission method comprising:
receiving a first packet;
measuring a first transmission rate of the received first packet;
generating a second packet such that a total of the first transmission rate of the first packet and a second transmission rate of the second packet becomes a predetermined value;
outputting the generated second packet to a path through which the received first packet has been transmitted, from among the plurality of paths.

8. The transmission method according to claim 7 further comprising
discarding the second packet when the second packet is detected on the path.

9. The transmission method according to claim 7 further comprising
suspending generation of the second packet when the measured transmission rate is the predetermined value or more.

10. The transmission method according to claim 7,
wherein the device is a device that is at a first stage through which the received packet passes first in the transmission device.

11. The transmission method according to claim 8,
wherein the processor is a processor included in each of the plurality of devices.

12. The transmission method according to claim 7,
wherein the outputting includes outputting the second packet to a first path, and
the method further comprising
when the second packet on the first path is looped back to a second path by a switch coupled to a device that is at a last stage from among the plurality of devices and when the second packet is detected on the second path, discarding the second packet.
